(19) United States
(12) Patent Application Publication
(10) Pub. No.: US 2024/0171301 A1
(43) Pub. Date: May 23, 2024

(54) MACHINE LEARNING DEVICE AND JAMMING SIGNAL GENERATION APPARATUS

(71) Applicant: MITSUBISHI ELECTRIC CORPORATION, Tokyo (JP)

(72) Inventor: Takumi MURATA, Tokyo (JP)

(73) Assignee: MITSUBISHI ELECTRIC CORPORATION, Tokyo (JP)

(21) Appl. No.: 18/237,715

(22) Filed: Aug. 24, 2023

Related U.S. Application Data
(63) Continuation of application No. PCT/JP2021/013912, filed on Mar. 31, 2021.

(51) Int. Cl. H04K 3/00

(52) U.S. Cl. CPC H04K 3/827; H04K 3/224

(57) ABSTRACT

A machine learning device includes: a transmission signal generation unit generating a transmission signal by simulating processing in communication as a jamming target; a first communication channel unit receiving the transmission signal and performing processing with a communication channel for jamming being simulated; a jamming signal generation unit generating the jamming signal by input of a data set based on output from the first communication channel unit to a machine learning model; a second communication channel unit receiving the transmission signal and the jamming signal and performing processing with a communication channel of the jamming target being simulated; an information restoration unit outputting restoration information by simulating processing in the jamming target, based on a signal outputted from the second communication channel unit; and a loss calculation unit updating the machine learning model, based on the result of calculating a loss of the restoration information.

### CROSS-REFERENCE TO RELATED APPLICATION

This application is a continuation application of International Application PCT/JP2021/013912, filed on Mar. 31, 2021, and designating the U.S., the entire contents of which are incorporated herein by reference.

### BACKGROUND OF THE INVENTION

### 1. Field of the Invention

The present disclosure relates to a machine learning device that generates a machine learning model for generating a jamming signal and a jamming signal generation apparatus.

### 2. Description of the Related Art

As a method of jamming communication, there has been known a method of radiating a continuous wave, noise, a modulated wave, or the like in the same frequency band as that of a communication wave. Non Patent Literature 1, SaiDhiraj Amuru, R. Michael Buehrer, “Optimal Jamming Against Digital Modulation”, IEEE Transactions on Information Forensics and Security, Vol. 10, No. 10, pp. 2212-2224, October, 2015, discloses a method of generating a jamming wave by which a high jamming effect can be expected for each modulation scheme in communication that is a jamming target. Japanese Patent No. 2596342 discloses a method in which a communication wave in a jamming target is acquired, and a jamming wave is generated in a form in which a signal phase is switched in a discontinuous way. Another method in Japanese Patent No. 2596342 jams communication by causing a communication wave and a jamming wave to interfere with each other, thereby generating pseudo fading to cause a reception error to occur.

The technique of Japanese Patent No. 2596342 listed above, however, has suffered from a problem that it cannot exert a jamming effect on a communication system in which measures against fading have been taken. The technique of the above Non Patent Literature 1 listed above is a technique for existing schemes that use additive white Gaussian noise (AWGN) or a modulated wave. In view of these techniques, there has been some demand to enable a jamming signal having a higher jamming effect to be generated.

### SUMMARY OF THE INVENTION

In order to solve the above-mentioned problem and achieve the object, the present disclosure provides a machine learning device that generates a machine learning model for generating a jamming signal used to jam communication, the machine learning device comprising: a transmission signal generation circuit to generate a transmission signal by simulating processing in communication that is a jamming target; a first communication channel circuit to receive input of the transmission signal and perform processing with a communication channel for jamming being simulated; a jamming signal generation circuit to generate the jamming signal by input of a data set based on output from the first communication channel circuit to a machine learning model; a second communication channel circuit to receive input of the transmission signal and the jamming signal and perform processing with a communication channel of the jamming target being simulated; an information restoration circuit to output restoration information by simulating processing in the jamming target, based on a signal outputted from the second communication channel circuit; and a loss calculation circuit to update the machine learning model, based on a result of calculating a loss of the restoration information.

### BRIEF DESCRIPTION OF THE DRAWINGS

FIG. 1 is a diagram illustrating a configuration of a machine learning device according to a first embodiment;

FIG. 2 is a diagram illustrating a configuration example of a jamming signal generation unit included in the machine learning device according to the first embodiment;

FIG. 3 is a diagram illustrating a configuration example of hardware by which the machine learning device according to the first embodiment is implemented;

FIG. 4 is a diagram illustrating a configuration of a machine learning device according to a second embodiment;

FIG. 5 is a diagram illustrating a configuration of a machine learning device according to a third embodiment;

FIG. 6 is a diagram illustrating a configuration example of a jamming signal generation unit included in the machine learning device according to the third embodiment;

FIG. 7 is a diagram illustrating a configuration of a jamming signal generation apparatus according to a fourth embodiment;

FIG. 8 is a diagram illustrating a configuration example of hardware by which the jamming signal generation apparatus according to the fourth embodiment is implemented; and

FIG. 9 is a diagram illustrating a configuration of a jamming signal generation apparatus according to a fifth embodiment.

### DETAILED DESCRIPTION OF THE PREFERRED EMBODIMENTS

Hereinafter, a machine learning device and a jamming signal generation apparatus according to embodiments will be described in detail with reference to the drawings.

### First Embodiment

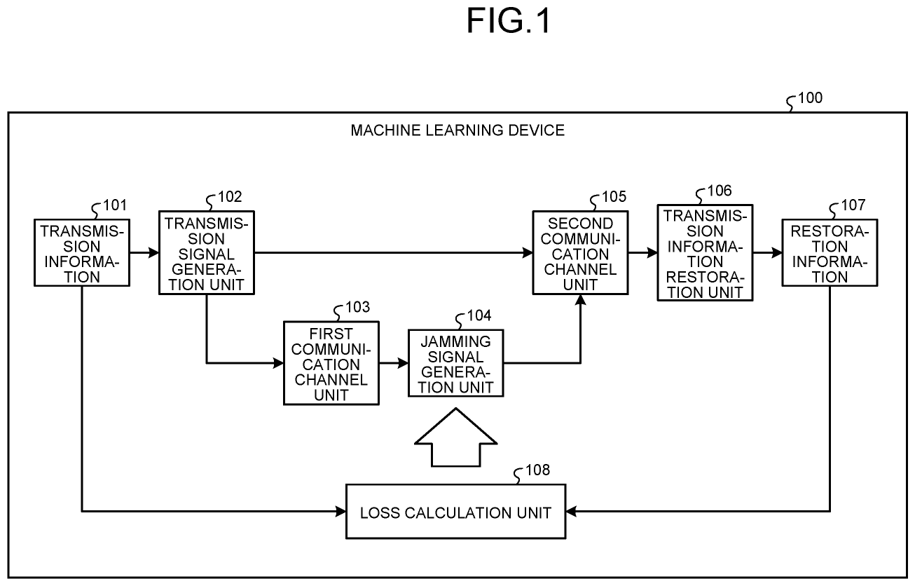

FIG. 1 is a diagram illustrating a configuration of a machine learning device 100 according to a first embodiment. The machine learning device 100 generates a machine learning model for generating a jamming signal used to jam communications.

The machine learning device 100 includes a transmission signal generation unit or circuit 102 that generates a transmission signal, a jamming signal generation unit or circuit 104 that generates a jamming signal according to the transmission signal, a transmission information restoration unit or circuit 106 that is an information restoration unit or circuit, and a loss calculation unit or circuit 108 that calculates a loss of restoration information 107. In addition, the machine learning device 100 includes a first communication channel unit or circuit 103 and a second communication channel unit or circuit 105 that perform processing with their respective radio communication channels being simulated.

The machine learning device 100 performs learning to optimize parameters of the machine learning model with use of a data set for learning. That is, the machine learning device 100 performs learning for generating an effective jamming signal. In order to effectively jam decoding of a received signal, the machine learning device 100 learns the machine learning model for obtaining a jamming signal that can maximize a decoding error.

The data set for learning is data corresponding to transmission information 101, which is composed of a bit sequence. In the loss calculation unit 108, the data set for learning is used as correct answer data for the restoration information 107.

The transmission information 101 is inputted to the transmission signal generation unit 102. The transmission signal generation unit 102 simulates processing in communication that is a jamming target, to accordingly generate a transmission signal. The transmission signal generation unit 102 simulates modulation of the transmission information 101 on a transmitting side in the communication that is the jamming target. Modulation processing performed by the transmission signal generation unit 102 may be either primary modulation such as phase shift keying (PSK), quadrature amplitude modulation (QAM), or frequency shift keying (FSK), or secondary modulation such as orthogonal frequency division multiplexing (OFDM), but is not limited to them. The transmission information 101 is acquired from, for example, the communication that is the jamming target.

The transmission signal is inputted to the first communication channel unit 103. The first communication channel unit 103 performs processing with a communication channel for jamming being simulated. The communication channel for jamming refers to a radio communication channel for communication performed by a jammer. The jammer said herein is an apparatus that receives a transmission signal as a jamming target and transmits a jamming signal. The first communication channel unit 103 performs processing such as AWGN or fading. The processing performed by the first communication channel unit 103 is not limited to them.

The transmission signal that has undergone the processing in the first communication channel unit 103 is inputted to the jamming signal generation unit 104. The jamming signal generation unit 104 generates a jamming signal by the input of the data set for learning based on output from the first communication channel unit 103 to the machine learning model.

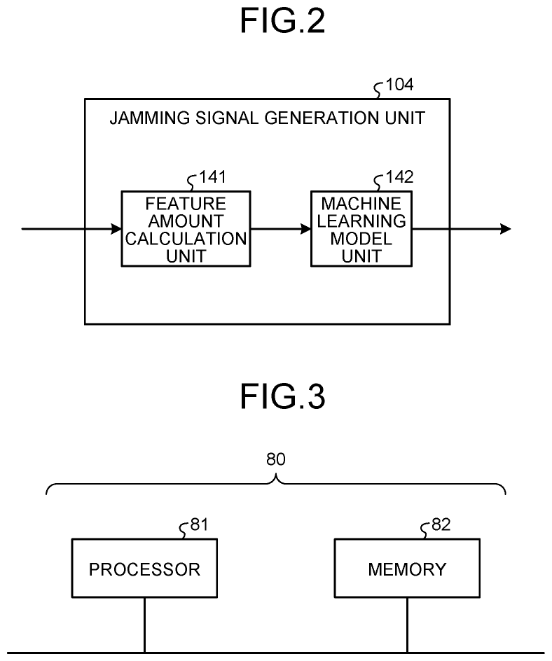

FIG. 2 is a diagram illustrating a configuration example of the jamming signal generation unit 104 included in the machine learning device 100 according to the first embodiment. The jamming signal generation unit 104 illustrated in FIG. 2 includes a feature amount calculation unit or circuit 141 and a machine learning model unit or circuit 142.

The feature amount calculation unit 141 calculates a feature amount of the signal outputted from the first communication channel unit 103. The signal outputted from the first communication channel unit 103 is obtained by simulating a received signal in the jammer. The said received signal is a transmission signal of the jamming target, which is received by the jammer. The feature amount calculated by the feature amount calculation unit 141 is a feature amount obtained from an in-phase signal I or a quadrature signal Q that is included in the signal outputted from the first communication channel unit 103. The feature amount calculated by the feature amount calculation unit 141 may be the amplitude or phase of each of the in-phase signal I and the quadrature signal Q. The feature amount calculated by the feature amount calculation unit 141 is not limited to this example. The feature amount calculation unit 141 calculates a time-series feature amount that is a feature amount varying in chronological order. The feature amount calculation unit 141 generates a feature amount in a format according to the input of the machine learning model. Hereinafter, the feature amount in the format according to the input of the machine learning model is sometimes referred to as an input feature amount.

In the machine learning model unit 142, a result of calculation of the feature amount in the feature amount calculation unit 141, that is, a data set for learning including an inputted feature amount is inputted to the machine learning model. The machine learning model is a model set to generate a jamming signal on the basis of an inputted feature amount. For the machine learning model, a multilayer perceptron (MLP), a convolutional neural network (CNN), an autoencoder (AE), a recurrent neural network (RNN), or the like can be used, but the present disclosure is not limited to these examples. When the data set for learning is inputted to the machine learning model, a jamming signal is outputted from the machine learning model.

The jamming signal generated by the jamming signal generation unit 104 is inputted to the second communication channel unit 105 together with the transmission signal. The second communication channel unit 105 performs processing with a communication channel of the jamming target being simulated. The communication channel of the jamming target is a radio communication channel in the communication of the jamming target. The second communication channel unit 105 performs processing such as AWGN or fading. The processing performed by the second communication channel unit 105 is not limited to these examples.

The transmission information restoration unit 106 is inputted with a signal that has undergone the processing in the second communication channel unit 105. A signal outputted from the second communication channel unit 105 is a signal obtained by simulation of a received signal in the communication that is the jamming target. The received signal is a signal received by a receiving apparatus that performs the communication that is the jamming target. Based on the signal outputted from the second communication channel unit 105, the transmission information restoration unit 106 simulates processing in the jamming target and outputs the restoration information 107. The transmission information restoration unit 106 performs demodulation processing according to the modulation processing in the transmission signal generation unit 102, thereby to simulate the restoration of the transmission information 101 at the receiving side in the communication that is the jamming target. The transmission information restoration unit 106 may use a neural network in the demodulation processing. From the transmission information restoration unit 106, the restoration information 107 that is the probability of bits outputted is outputted to the loss calculation unit 108.

The loss calculation unit 108 is outputted with the transmission information 101 and the restoration information 107. The loss calculation unit 108 calculates a loss of the restoration information 107 based on the transmission information 101 and the restoration information 107. The loss calculation unit 108 calculates a loss corresponding to a distance between the transmission information 101 that is the correct answer data and the restoration information 107.

The loss calculation unit 108 updates a weight for each parameter of the machine learning model, based on the loss calculation result. In this manner, the loss calculation unit 108 updates the machine learning model on the basis of the result of calculating the loss of the restoration information 107.

One of policies for updating a weight is a policy to minimize a loss function L. The loss function L is represented by the following equation (1), where i is an integer, tᵢ is the i-th correct answer data, and yᵢ is the i-th restoration information 107. The loss function L represented by the equation (1) is designed such that an error between the correct answer data and the restoration information 107 is made larger. The loss calculation unit 108 performs learning such that the loss function L is minimized, by repeating updating of the machine learning model.

Formula 1:

L=Σᵢ{−tᵢ log(1−yᵢ)−(1−tᵢ)log yᵢ} (1)

The policy for updating a weight may be a policy to maximize an index such as a mean squared error (MSE), a mean absolute error (MAE), a binary cross entropy (BCE), a categorical cross entropy (CCE), or a Kullback-Leibler (KL) divergence. The loss calculation unit 108 performs learning to maximize an index that is any one of the MSE, MAE, BCE, CCE, and KL divergence, by repeating updating of the machine learning model. Note that the policy for updating a weight is not limited to these examples.

Next, a hardware configuration to implement the machine learning device 100 will be described. FIG. 3 is a diagram illustrating a configuration example of hardware by which the machine learning device 100 according to the first embodiment is implemented. The configuration example illustrated in FIG. 3 is a configuration example in which the transmission signal generation unit 102, the first communication channel unit 103, the jamming signal generation unit 104, the second communication channel unit 105, the transmission information restoration unit 106, and the loss calculation unit 108 are implemented by a processing circuit 80 including a processor 81 and a memory 82.

The processor 81 is a central processing unit (CPU). The processor 81 may be an arithmetic device, a microprocessor, a microcomputer, or a digital signal processor (DSP). The memory 82 is, for example, random-access memory (RAM), read-only memory (ROM), flash memory, an erasable programmable read-only memory (EPROM), an electrically erasable programmable read-only memory (EEPROM) (registered trademark), or the like.

In the memory 82, there is stored a program for performing operations of the transmission signal generation unit 102, the first communication channel unit 103, the jamming signal generation unit 104, the second communication channel unit 105, the transmission information restoration unit 106, and the loss calculation unit 108, which are components of the machine learning device 100. The units of the machine learning device 100 can be implemented by the processor 81 reading and executing the program. The program for performing operations of the units of the machine learning device 100 stored in the memory 82 may be, for example, in a form of being provided by a user or the like in a state in which the program has been written in a storage medium such as a compact disc ROM (CD-ROM) or a digital versatile disc ROM (DVD-ROM), or in a form of being provided via a network.

FIG. 3 shows an example of hardware when the units of the machine learning device 100 are implemented by the processor 81 and the memory 82 which are general-purpose devices. However, in place of the processor 81 and the memory 82, the units of the machine learning device 100 may be implemented by a dedicated processing circuit. That is, a dedicated processing circuit may implement the units of the machine learning device 100. In this example, the dedicated processing circuit is a single circuit, a composite circuit, an application specific integrated circuit (ASIC), a field programmable gate array (FPGA), or a circuit in which some of these circuits are combined. Part of the transmission signal generation unit 102, the first communication channel unit 103, the jamming signal generation unit 104, the second communication channel unit 105, the transmission information restoration unit 106, and the loss calculation unit 108 may be implemented by the processor 81 and the memory 82, and the rest thereof may be implemented by a dedicated processing circuit.

According to the first embodiment, the machine learning device 100 generates a jamming signal based on a transmission signal, and generates the restoration information 107 by demodulation from the transmission signal and the jamming signal. In addition, the machine learning device 100 updates the machine learning model based on the result of calculating a loss of the restoration information 107. By the use of the machine learning model thus updated, a jamming signal to cause a decoding error to arise can be generated based on a transmission signal. By learning, the machine learning device 100 can improve the jamming effect of a jamming signal generated by the use of the machine learning model. That is, the machine learning device 100 enables generation of a jamming signal such that a decoding error in a jamming target is maximized. As described above, the machine learning device 100 has the effect of enabling generation of a jamming signal having a higher jamming effect.

### Second Embodiment

In the first embodiment, what has been provided in the machine learning device 100 for jamming communications by a decoding error. In a second embodiment, description is given for a case where communication is jammed under a policy different from that of the first embodiment. A machine learning device 200 according to the second embodiment generates a machine learning model for jamming synchronization of communication waves.

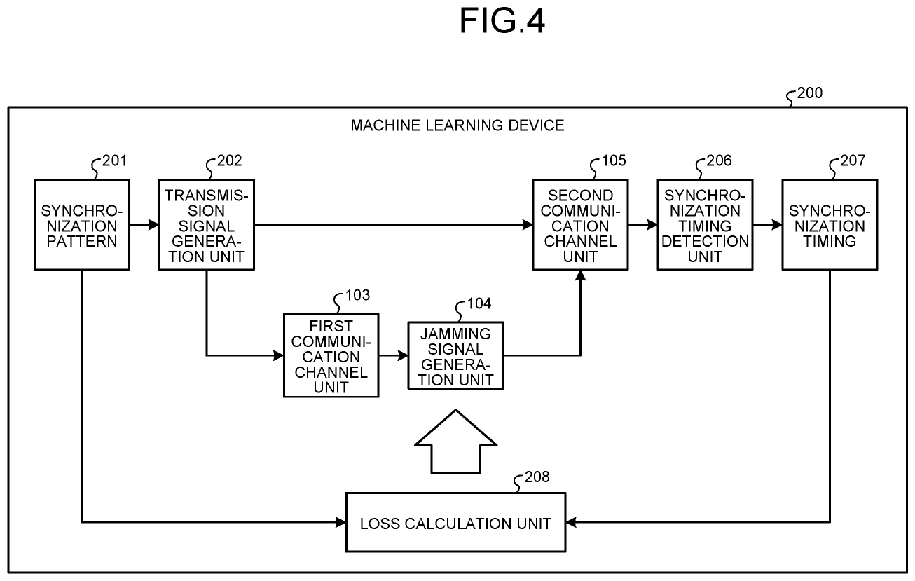

FIG. 4 is a diagram illustrating a configuration of the machine learning device 200 according to the second embodiment. The machine learning device 200 generates a machine learning model for generating a jamming signal used to jam communication. In the second embodiment, the same reference numerals are assigned to the same components as those in the above first embodiment, and a configurational part different from that of the first embodiment will be mainly described.

The machine learning device 200 includes a transmission signal generation unit or circuit 202 that generates a transmission signal from a synchronization pattern 201, the jamming signal generation unit 104 that generates a jamming signal according to the transmission signal, a synchronization timing detection unit or circuit 206 that is an information restoration unit or circuit, and a loss calculation unit or circuit 208 that calculates a loss of restoration information. In addition, the machine learning device 200 includes the first communication channel unit 103 and the second communication channel unit 105, which perform processing with their respective radio communication channels being simulated. In order to effectively jam synchronization of the transmission signal, the machine learning device 200 learns a machine learning model for obtaining a jamming signal with use of which a synchronization error can be maximized.

The transmission signal generation unit 202 is inputted with a signal of the synchronization pattern 201. The transmission signal generation unit 202 simulates processing in communication that is a jamming target, and accordingly generates a transmission signal. The transmission signal generation unit 202 generates the transmission signal by simulating modulation according to the synchronization pattern 201 in the jamming target. The transmission signal is inputted to the first communication channel unit 103 and the second communication channel unit 105.

The synchronization timing detection unit 206 is inputted with the signal that has undergone the processing in the second communication channel unit 105. The synchronization timing detection unit 206 detects a synchronization timing 207 from the signal outputted from the second communication channel unit 105 to thereby output restoration information that is a signal of the synchronization timing 207. The synchronization timing detection unit 206 may use a neural network in the detection of the synchronization timing 207. The synchronization timing detection unit 206 outputs the signal of the synchronization timing 207 to the loss calculation unit 208.

The loss calculation unit 208 is inputted with the signal of the synchronization pattern 201 and the signal of the synchronization timing 207. The loss calculation unit 208 calculates a loss of the synchronization timing 207 based on the synchronization pattern 201 and the synchronization timing 207. The loss calculation unit 208 calculates a loss corresponding to a distance between an ideal timing that is correct answer data and the synchronization timing 207. The ideal timing is a timing according to the synchronization pattern 201.

The loss calculation unit 208 updates a weight of each parameter of the machine learning model on the basis of the loss calculation result. Thus, the loss calculation unit 208 updates the machine learning model based on the result of calculating the loss of the synchronization timing 207. An example of a policy for updating a weight is a policy to maximize an index such as MSE or MAE. The loss calculation unit 208 performs learning to maximize an index that is MSE or MAE by repeating updating of the machine learning model. Note that the policy for updating a weight is not necessarily limited to these examples.

The machine learning device 200 can be implemented by the hardware configuration illustrated in FIG. 3, as is the case with the machine learning device 100 according to the first embodiment. The first communication channel unit 103, the jamming signal generation unit 104, the second communication channel unit 105, the transmission signal generation unit 202, the synchronization timing detection unit 206, and the loss calculation unit 208, which are the units of the machine learning device 200, can be implemented by the processing circuit 80 including the processor 81 and the memory 82. Each unit of the machine learning device 200 may be implemented by a dedicated processing circuit.

According to the second embodiment, the machine learning device 200 generates a jamming signal based on a transmission signal, and detects the synchronization timing 207 from the transmission signal and the jamming signal. In addition, the machine learning device 200 updates the machine learning model based on the result of calculating a loss of the synchronization timing 207. By the use of the machine learning model, a jamming signal to cause a synchronization error can be generated based on a transmission signal. By the learning, the machine learning device 200 can improve the jamming effect of a jamming signal generated by the use of the machine learning model. That is, it is possible to generate a jamming signal such that maximization of a synchronization error in a jamming target can be achieved. As described above, the machine learning device 200 has an advantageous effect of enabling generation of a jamming signal having a higher jamming effect.

### Third Embodiment

In the first and second embodiments, description has been given for the configurations on the assumption of an environment where specifications of communication such as a frequency band used by the jamming target are known. However, in actual operation, it is conceivable that communication whose protocol is not known is to be jammed. To address such a situation, in a third embodiment, description will be given for a configuration in which specification analysis of communication is incorporated.

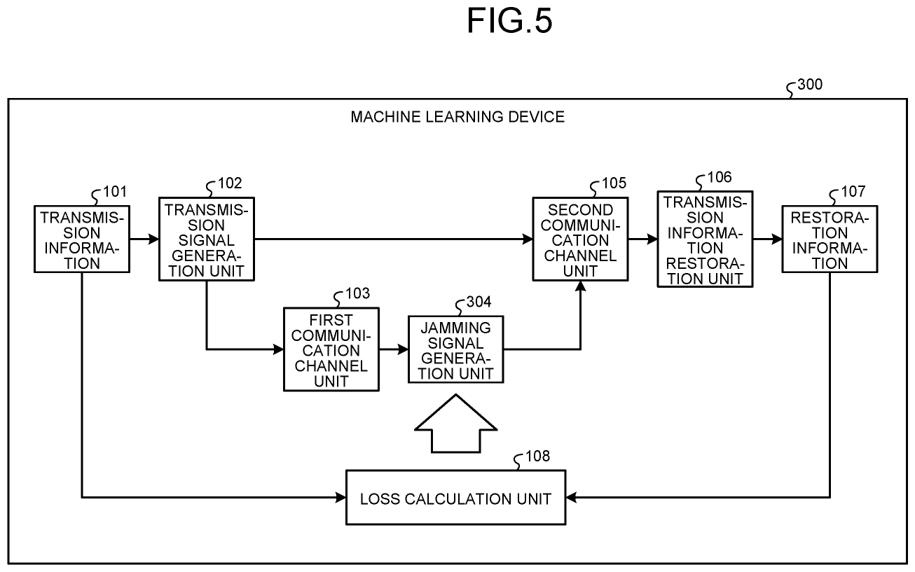

FIG. 5 is a diagram illustrating a configuration of a machine learning device 300 according to the third embodiment. The machine learning device 300 generates a machine learning model for generating a jamming signal used to jamt communication. In the third embodiment, the same reference numerals are assigned to the same components as those in the first or second embodiment described above, and a configurational part different from that of the first or second embodiment will be mainly described.

The machine learning device 300 includes the transmission signal generation unit 102 that generates a transmission signal, a jamming signal generation unit or circuit 304 that generates a jamming signal according to the transmission signal, the transmission information restoration unit 106 that is an information restoration unit or circuit, and the loss calculation unit 108 that calculates a loss of the restoration information 107. In addition, the machine learning device 300 includes the first communication channel unit 103 and the second communication channel unit 105, which perform processing with their respective radio communication channels being simulated.

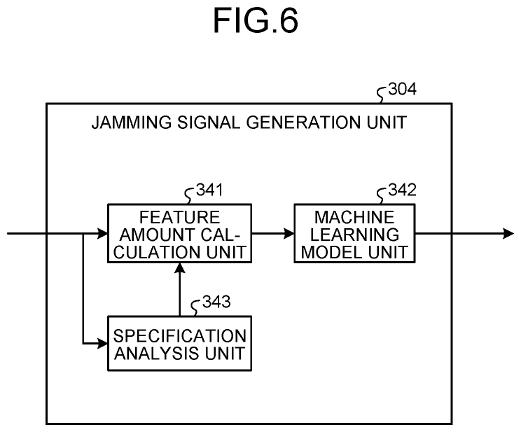

FIG. 6 is a diagram illustrating a configuration example of the jamming signal generation unit 304 included in the machine learning device 300 according to the third embodiment. The jamming signal generation unit 304 illustrated in FIG. 6 includes a feature amount calculation unit or circuit 341, a machine learning model unit or circuit 342, and a specification analysis unit or circuit 343.

As in the feature amount calculation unit 141 of the first embodiment, the feature amount calculation unit 341 calculates a time-series feature amount that is a feature amount of a signal outputted from the first communication channel unit 103. The specification analysis unit 343 analyzes specifications of a communication wave in a jamming target to thereby determine estimate values of the specifications. The estimate values obtained by the specification analysis unit 343 are inputted to the feature amount calculation unit 341. The specification analysis unit 343 analyzes specifications of a communication wave such as frequency and a symbol rate thereof. The specifications to be analyzed by the specification analysis unit 343 are not necessarily limited to these examples.

The feature amount calculation unit 341 obtains an input feature amount on the basis of the time-series feature amount and the estimate values of the specifications. In the machine learning model unit 342, a data set for learning including the input feature amount is inputted to a machine learning model thereof. The data set for learning includes the estimate values of the specifications. Note that the input feature amount described here is just an example, which is not intended to limit the present disclosure. As the input feature amount, only either the time-series feature amount or the feature amount obtained from the estimate values of the specifications may be used.

The machine learning device 300 can be implemented by the hardware configuration illustrated in FIG. 3, as is the case with the machine learning device 100 according to the first embodiment. The transmission signal generation unit 102, the first communication channel unit 103, the second communication channel unit 105, the transmission information restoration unit 106, the loss calculation unit 108, and the jamming signal generation unit 304, which are the units of the machine learning device 300, can be implemented by the processing circuit 80 including the processor 81 and the memory 82. Each unit of the machine learning device 300 may be implemented by a dedicated processing circuit. The specification analysis of communication according to the third embodiment may be combined with either the configuration of the first embodiment or the configuration of the second embodiment.

According to the third embodiment, by analyzing the specifications of a communication wave, the machine learning device 300 can perform learning after recognizing the specifications of the communication wave. Consequently, the machine learning device 300 has an advantageous effect of enabling generation of a jamming signal having a higher jamming effect in a situation where the specifications of a communication wave are unknown.

### Fourth Embodiment

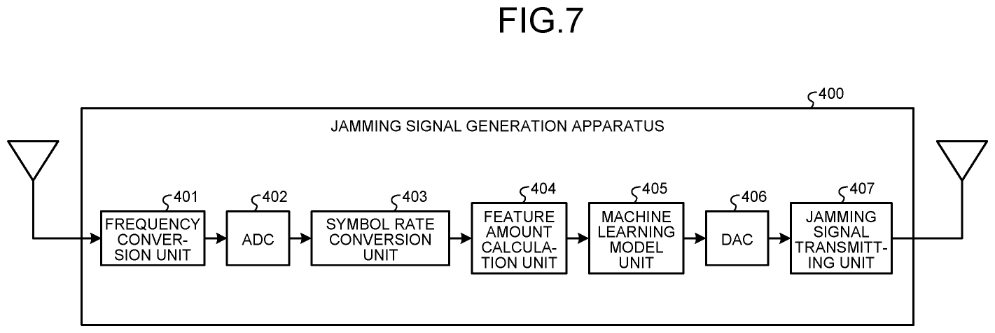

A fourth embodiment presents an example in which generation of a jamming signal using a machine learning model is applied to wireless communication. FIG. 7 is a diagram illustrating a configuration of a jamming signal generation apparatus 400 according to the fourth embodiment.

The jamming signal generation apparatus 400 generates a jamming signal used to jam communication, with use of a machine learning model, and transmits the generated jamming signal. The machine learning model is the machine learning model generated by the machine learning device 100 according to the first embodiment or the machine learning device 200 according to the second embodiment.

The jamming signal generation apparatus 400 receives a transmission signal in communication that is a jamming target. The jamming signal generation apparatus 400 includes: a frequency conversion unit or circuit 401 that performs frequency conversion of the received transmission signal; an analog-to-digital converter (ADC) 402 that converts the transmission signal in analog form into a digital signal; a symbol rate conversion unit or circuit 403 that converts the symbol rate of the digital signal obtained by the conversion; a feature amount calculation unit or circuit 404 that calculates a feature amount; a machine learning model unit or circuit 405 that outputs a jamming signal according to the feature amount; a digital-to-analog converter (DAC) 406 that converts the jamming signal in digital form into an analog signal; and a jamming signal transmitting unit or circuit 407 that converts the jamming signal that is an analog signal into a radio frequency (RF) signal. The jamming signal generation apparatus 400 transmits the jamming signal that is the RF signal.

A transmission signal received by the jamming signal generation apparatus 400 is a transmission signal in an RF band. The frequency conversion unit 401 performs frequency conversion of the transmission signal from the RF band into baseband. The transmission signal is converted from the analog signal into a digital signal by the ADC 402. The symbol rate conversion unit 403 converts the symbol rate of the digital signal into a symbol rate suitable for processing in and after the symbol rate conversion unit 403. Specifically, the symbol rate suitable for the processing in and after the symbol rate conversion unit 403 is a symbol rate suitable for calculation of the feature amount. The digital signal having the symbol rate after the conversion is inputted to the feature amount calculation unit 404.

The feature amount calculation unit 404 calculates, from the inputted digital signal, a feature amount of the signal. The feature amount calculated by the feature amount calculation unit 404 is a time-series feature amount obtained from the in-phase signal I or the quadrature signal Q of the transmission signal. The feature amount calculated by the feature amount calculation unit 404 may be the amplitude or phase of each of the in-phase signal I and the quadrature signal Q. The feature amount calculated by the feature amount calculation unit 404 is not necessarily limited to these examples. The feature amount calculation unit 404 calculates, from the inputted digital data, an input feature amount that is a time-series feature amount in a format according to the input of the machine learning model.

In the machine learning model unit 405, a data set for learning including the input feature amount is inputted to the machine learning model. When the data set for learning has been inputted to the machine learning model, a jamming signal is outputted from the machine learning model. Thus, the jamming signal generation apparatus 400 generates a jamming signal using the feature amount calculation unit 404 and the machine learning model unit 405. The generated jamming signal is converted from the digital signal into an analog signal by the DAC 406. The analog jamming signal obtained by the conversion is converted into an RF signal by the jamming signal transmitting unit 407. The jamming signal as the RF signal obtained by the conversion is transmitted from the jamming signal generation apparatus 400.

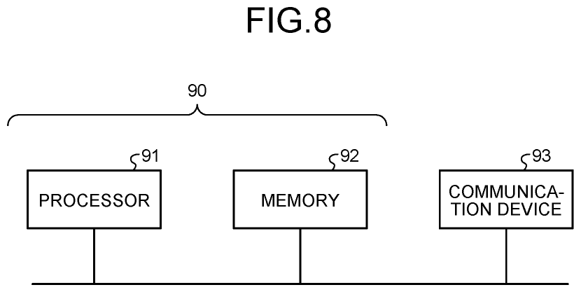

Next, a hardware configuration to implement the jamming signal generation apparatus 400 will be described. FIG. 8 is a diagram illustrating a configuration example of hardware by which the jamming signal generation apparatus 400 according to the fourth embodiment is implemented. The configuration example illustrated in FIG. 8 is a configuration example in which the frequency conversion unit 401, the ADC 402, the symbol rate conversion unit 403, the feature amount calculation unit 404, the machine learning model unit 405, the DAC 406, and the jamming signal transmitting unit 407 are implemented by a processing circuit 90 including a processor 91 and memory 92.

The processor 91 and the memory 92 are similar to the processor 81 and the memory 82 illustrated in FIG. 3, and thus their redundant description is omitted. A communication device 93 performs signal transmission and signal reception. The communication device 93 receives a transmission signal of a jamming target. The communication device 93 transmits a jamming signal.

In the memory 92, there is stored a program for performing operations of the frequency conversion unit 401, the ADC 402, the symbol rate conversion unit 403, the feature amount calculation unit 404, the machine learning model unit 405, the DAC 406, and the jamming signal transmitting unit 407, which are the units of the jamming signal generation apparatus 400. Each unit of the jamming signal generation apparatus 400 can be implemented by the processor 91 reading out and executing the program. The program for performing operations of the units of the jamming signal generation apparatus 400, which is stored in the memory 92, may be in the form of being provided by a user or the like in a state where the program has been written in a storage medium, or may be in the form of being provided via a network.

FIG. 8 is an example of hardware in the case where the units of the jamming signal generation apparatus 400 are implemented by the general-purpose processor 91 and the general-purpose memory 92. Instead of the processor 91 and the memory 92, the units of the jamming signal generation apparatus 400 may be implemented by a dedicated processing circuit. That is, a dedicated processing circuit may implement the units of the jamming signal generation apparatus 400. Part of the frequency conversion unit 401, the ADC 402, the symbol rate conversion unit 403, the feature amount calculation unit 404, the machine learning model unit 405, the DAC 406, and the jamming signal transmitting unit 407 may be implemented by the processor 91 and the memory 92, and the rest thereof may be implemented by a dedicated processing circuit. The function of receiving a transmission signal of a jamming target or the function of transmitting a jamming signal may be implemented by a configuration separate from the jamming signal generation apparatus 400.

According to the fourth embodiment, the jamming signal generation apparatus 400 generates a jamming signal using the machine learning model generated by the machine learning device 100 or 200. As a result, the jamming signal generation apparatus 400 has an advantageous effect of being able to generate a jamming signal having a higher jamming effect.

### Fifth Embodiment

In the fourth embodiment, there has been described the configuration for the case where communication specifications such as a band used by the jamming target are known. In a fifth embodiment, description will be given for a configuration using communication specification analysis in a situation where communication specifications are unknown.

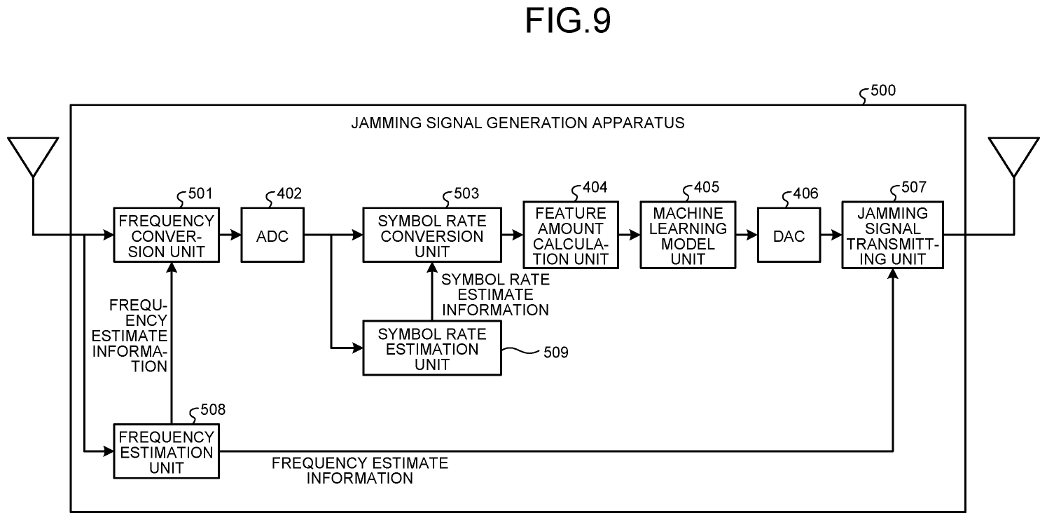

FIG. 9 is a diagram illustrating a configuration of a jamming signal generation apparatus 500 according to the fifth embodiment. In the fifth embodiment, the same reference numerals are assigned to the same components as those in the fourth embodiment, and a configurational part different from that of the fourth embodiment will be mainly described.

The jamming signal generation apparatus 500 generates a jamming signal used to jam communication, using a machine learning model, and transmits the generated jamming signal. The machine learning model is a machine learning model generated by the machine learning device 300 according to the third embodiment.

The jamming signal generation apparatus 500 receives a transmission signal in communication that is a jamming target. The jamming signal generation apparatus 500 includes: a frequency conversion unit or circuit 501 that performs frequency conversion of the received transmission signal; the ADC 402 that converts the transmission signal in analog form into a digital signal; a symbol rate conversion unit or circuit 503 that converts the symbol rate of the transmission signal obtained by digital conversion; the feature amount calculation unit 404 that calculates a feature amount; the machine learning model unit 405 that outputs a jamming signal according to the feature amount; the DAC 406 that converts the jamming signal in digital form into an analog signal; and a jamming signal transmitting unit or circuit 507 that converts the jamming signal that is an analog signal into an RF signal. Furthermore, the jamming signal generation apparatus 500 includes a frequency estimation unit or circuit 508 that estimates, from the received transmission signal, the frequency of the transmission signal, and a symbol rate estimation unit or circuit 509 that estimates, from the digital signal obtained by the digital conversion of the ADC 402, the symbol rate of the transmission signal.

A transmission signal received by the jamming signal generation apparatus 500 is a transmission signal in an RF band. The received transmission signal is inputted to each of the frequency conversion unit 501 and the frequency estimation unit 508. For estimation in frequency performed by the frequency estimation unit 508, an existing method for analyzing communication wave specifications can be used. The frequency estimation unit 508 estimates the frequency of the transmission signal and transmits frequency estimate information indicating the frequency estimation result to the frequency conversion unit 501. The frequency conversion unit 501 performs frequency conversion of the transmission signal from the RF band to a baseband, using the frequency estimate information. The transmission signal is converted from the analog signal into a digital signal by the ADC 402.

The digital transmission signal obtained by the conversion of the ADC 402 is inputted to each of the symbol rate conversion unit 503 and the symbol rate estimation unit 509. The symbol rate estimation unit 509 performs symbol rate estimation processing on the transmission signal. The symbol rate estimation unit 509 transmits symbol rate estimate information indicating the symbol rate estimation result to the symbol rate conversion unit 503. The symbol rate conversion unit 503 converts the symbol rate of the digital signal, using the symbol rate estimate information. The symbol rate conversion unit 503 converts the symbol rate into a symbol rate suitable for processing in and after the symbol rate converter 503, specifically, calculation processing of a feature amount. Digital data whose symbol rate has been converted is inputted to the feature amount calculation unit 404.

The jamming signal generation apparatus 500 generates a jamming signal using the feature amount calculation unit 404 and the machine learning model unit 405. The feature calculation unit 404 obtains an input feature amount based on a time-series feature amount and estimate values of specifications of the transmission signal. In the machine learning model unit 405, a data set for learning including the input feature amount is inputted to the machine learning model. The data set for learning includes the estimate values of the specifications of the transmission signal. Note that the input feature amount described here is just an example, and the present disclosure is not limited to this example. As the input feature amount, only either the time-series feature amount or the feature amount obtained from the estimate values of the specifications may be used.

The generated jamming signal is converted from the digital signal into an analog signal by the DAC 406. The jamming signal transmitting unit 507 performs frequency conversion of the jamming signal into a frequency band indicated by the frequency estimate information. The jamming signal having been subjected to the frequency conversion is transmitted from the jamming signal generation apparatus 500.

The jamming signal generation apparatus 500 can be implemented by the hardware configuration illustrated in FIG. 8, as is the case with the jamming signal generation apparatus 400 according to the fourth embodiment. The ADC 402, the feature amount calculation unit 404, the machine learning model unit 405, the DAC 406, the frequency conversion unit 501, the symbol rate conversion unit 503, the jamming signal transmitting unit 507, the frequency estimation unit 508, and the symbol rate estimation unit 509, which are the units of the jamming signal generation apparatus 500, can be implemented by the processing circuit 90 including the processor 91 and the memory 92. Each unit of the jamming signal generation apparatus 500 may be implemented by a dedicated processing circuit. The function of receiving a transmission signal of a jamming target or the function of transmitting a jamming signal may be implemented by a configuration separate from the jamming signal generation apparatus 500.

According to the fifth embodiment, the jamming signal generation apparatus 500 performs frequency conversion for generating a jamming signal and frequency conversion for transmitting the jamming signal, using frequency estimate information. The jamming signal generation apparatus 500 performs symbol rate conversion for generating a jamming signal, using symbol rate estimate information. Consequently, the jamming signal generation apparatus 500 has an advantageous effect of being able to generate a jamming signal having a higher jamming effect in a situation where specifications of a communication wave are unknown.

The machine learning device according to the present disclosure has an advantageous effect that it can generate a jamming signal having a higher jamming effect.

The configuration described in each of the above embodiments illustrates an example of the contents of the present disclosure. The configuration of each embodiment can be combined with other publicly known techniques. The configurations of the embodiments may be combined with each other as appropriate. The configuration of each embodiment can be partly omitted and/or modified without departing from the scope of the present disclosure.

What is claimed is:

1. A machine learning device that generates a machine learning model for generating a jamming signal used to jam communication,
the machine learning device comprising:
a transmission signal generation circuit to generate a transmission signal by simulating processing in communication that is a jamming target;
a first communication channel circuit to receive input of the transmission signal and perform processing with a communication channel for jamming being simulated;
a jamming signal generation circuit to generate the jamming signal by input of a data set based on output from the first communication channel circuit to the machine learning model;
a second communication channel circuit to receive input of the transmission signal and the jamming signal and perform processing with a communication channel of the jamming target being simulated;
an information restoration circuit to output restoration information by simulating processing in the jamming target, based on a signal outputted from the second communication channel circuit; and
a loss calculation circuit to update the machine learning model, based on a result of calculating a loss of the restoration information.

2. The machine learning device according to claim 1,
wherein the information restoration circuit generates the restoration information using a neural network.

3. The machine learning device according to claim 1, wherein
the transmission signal generation circuit generates the transmission signal by simulating modulation of transmission information in the jamming target,
the information restoration circuit generates the restoration information by demodulation of the signal outputted from the second communication channel circuit, and
the loss calculation circuit calculates the loss corresponding to a distance between the transmission information that is correct answer data and the restoration information.

4. The machine learning device according to claim 1, wherein
the transmission signal generation circuit generates the transmission signal by simulating modulation according to a synchronization pattern in the jamming target,
the information restoration circuit detects a synchronization timing from a signal outputted from the second communication channel circuit, to thereby output the restoration information that is a signal of the synchronization timing, and
the loss calculation circuit calculates the loss corresponding to a distance between correct answer data that is a timing according to the synchronization pattern and the synchronization timing.

5. The machine learning device according to claim 3, wherein the loss calculation circuit repeats update of the machine learning model to thereby perform learning to minimize a loss function L represented by an expression (1) next, where i is an integer, tᵢ is the i-th correct answer data, and yᵢ is the i-th restoration information:
$$\begin{matrix}Formula 1 & \\ L = {\sum }_{i} \{ - {t}_{i} log ( 1 - {y}_{i} ) - ( 1 - {t}_{i} ) log {y}_{i} \} & ( 1 )\end{matrix}$$

6. The machine learning device according to claim 4, wherein the loss calculation circuit repeats update of the machine learning model to thereby perform learning to minimize a loss function L represented by an expression (1) next, where i is an integer, tᵢ is the i-th correct answer data, and yᵢ is the i-th restoration information:
$$\begin{matrix}Formula 1 & \\ L = {\sum }_{i} \{ - {t}_{i} log ( 1 - {y}_{i} ) - ( 1 - {t}_{i} ) log {y}_{i} \} & ( 1 )\end{matrix}$$

7. The machine learning device according to claim 3, wherein the loss calculation circuit repeats update of the machine learning model to thereby perform learning to maximize an index that is one of mean squared error, mean absolute error, binary cross entropy, categorical cross entropy, and the Kullback-Leibler divergence.

8. The machine learning device according to claim 4, wherein the loss calculation circuit repeats update of the machine learning model to thereby perform learning to maximize an index that is one of mean squared error, mean absolute error, binary cross entropy, categorical cross entropy, and the Kullback-Leibler divergence.

9. The machine learning device according to claim 1, wherein
the jamming signal generation circuit includes a specification analysis circuit to analyze specifications of a communication wave in the jamming target to thereby obtain estimate values of the specifications, and
the data set includes the estimate values.

10. The machine learning device according to claim 1,
wherein
the jamming signal generation circuit includes a feature amount calculation circuit to calculate a feature amount of a signal outputted from the first communication channel circuit, and
the data set includes a result of calculation of the feature amount.

11. The machine learning device according to claim 10, wherein the feature amount is a feature amount obtained from an in-phase signal or a quadrature signal of the transmission signal, which varies in chronological order.

12. The machine learning device according to claim 10, wherein the feature amount is estimate values of specifications of the transmission signal.

13. A jamming signal generation apparatus that generates a jamming signal used to jam communication, using the machine learning model generated by the machine learning device according to claim 1.

14. The jamming signal generation apparatus according to claim 13, comprising:
a feature amount calculation circuit to calculate a feature amount of a transmission signal in communication that is a jamming target; and
a machine learning model circuit to output the jamming signal by input of a data set including the feature amount to the machine learning model.

15. The jamming signal generation apparatus according to claim 14, wherein the feature amount is a feature amount obtained from an in-phase signal or a quadrature signal of the transmission signal, which varies in chronological order.

16. The jamming signal generation apparatus according to claim 14, wherein the feature amount is estimate values of specifications of the transmission signal.
